(19) United States
(12) Patent Application Publication
(10) Pub. No.: US 2022/0152541 A1
(43) Pub. Date: May 19, 2022

(54) CONCENTRIC FILTER SYSTEMS AND METHODS FOR AIR TREATMENT

(71) Applicant: Field Controls, L.L.C., Kinston, NC (US)

(72) Inventors: Gareth W. D. Lewis, Wilmington, NC (US); Brent Hamilton Holloway, Chapel Hill, NC (US)

(73) Assignee: Field Controls, L.L.C., Kinston, NC (US)

(21) Appl. No.: 17/523,221

(22) Filed: Nov. 10, 2021

Related U.S. Application Data
(60) Provisional application No. 63/114,155, filed on Nov. 16, 2020.
(60) Provisional application No. 63/136,355, filed on Jan. 12, 2021.

(51) Int. Cl. B01D 46/00; B01D 53/86; F24F 8/22

(52) U.S. Cl. CPC B01D 46/0036; B01D 53/86; B01D 2255/802; B01D 2253/102; B01D 2257/91; F24F 8/22

(57) ABSTRACT

Systems for treatment of air are provided. In one embodiment, a system comprises a pre-filter layer, a smaller particle filtration layer, a carbon layer and a photocatalytic layer. Among the four layers, the pre-filter layer may be the furthest upstream in a direction of air flow, and the photocatalytic layer may be the furthest downstream in a direction of air flow.

### PRIORITY CLAIM

This application claims the benefit of priority under 35 U.S.C. § 119(e) of U.S. Provisional Patent Application Ser. No. 63/136,355, filed Jan. 12, 2021, and further claims the benefit of priority under 35 U.S.C. § 119(e) of U.S. Provisional Patent Application Ser. No. 63/114,155, filed Nov. 16, 2020. Each of the foregoing applications are hereby incorporated by reference in their entirety.

### BACKGROUND

The present embodiments relate generally to filter arrangements and methods for air treatment, for example, using concentric filter arrangements.

A multitude of components that treat fluids, such as air, exists in both residential and commercial environments. Different types of air treatment units abound and incorporate filters that are removable for cleaning and/or replacement.

In various systems, fresh air flows through filter media that intercepts and retains airborne particles. The filter media is commonly secured to a frame that is designed to be placed into a housing, duct or conduit during operation, and removed therefrom for cleaning or replacement. Such filters may comprise a pre-filter layer to capture very large particles, or a high efficiency particulate air filtration (“HEPA”) layer designed to capture smaller particles.

In other systems, it is known that light of the “C” band of the ultraviolet spectrum, with wavelengths between approximately 220 and 288 nanometers (“UV light”), can control growth of or kill most contaminants currently known to exist within certain air flow conduits, such as HVAC systems. Lamps capable of emitting UV light typically comprise a long, hollow cylinder containing one or more gases therein that will, upon being excited by electric current, emit UV light. These UV lamps primarily radiate UV light in a direction perpendicular to the surface from which the light emanates.

While such exemplary modalities are known in isolated contexts for treatment of air, improved systems are desirable to provide enhanced cleaning and purification in a simple to use manner, which are easy to operate and allow for optional replacement of filter media.

### SUMMARY

Systems are provided for treatment of air. In one embodiment, a system comprises a pre-filter layer, a smaller particle filtration layer, a carbon layer and a photocatalytic layer. Among the four layers, the pre-filter layer may be the furthest upstream in a direction of air flow, and the photocatalytic layer may be the furthest downstream in a direction of air flow.

In one example, the pre-filter layer is upstream in a direction of air flow relative to the smaller particle filtration layer, the smaller particle filtration layer is upstream in a direction of air flow relative to the carbon layer, and the carbon layer is upstream in a direction of air flow relative to the photocatalytic layer. The system may comprise an ultraviolet light, which may be disposed downstream from the photocatalytic layer in a direction of air flow.

In one embodiment, a filter arrangement is provided in which each of the pre-filter layer, the smaller particle filtration layer, the carbon layer, and the photocatalytic layer comprise a continuous cylindrical layer. In this example, the filter arrangement may be secured to a frame having a lower frame segment and an upper frame segment, with an open central region disposed between the lower and upper frame segments. The system may further comprise a housing having a spring-loaded base, where the lower frame segment of the frame is configured to be biased upward by the spring-loaded base in an assembled state.

In another embodiment, a filter arrangement is provided having first and second segments. The first segment may comprise generally clam-shaped portions of each of the pre-filter layer, the smaller particle filtration layer, the carbon layer, and the photocatalytic layer. The second segment may comprise generally clam-shaped portions of each of the pre-filter layer, the smaller particle filtration layer, the carbon layer, and the photocatalytic layer. During use, the first and second segments may be positioned adjacent to one another to form a substantially cylindrical shape. The first segment of the filter arrangement may be secured to a frame having a lower frame segment spanning less than 180 degrees, an upper frame segment spanning less than 180 degrees, and first and second upraised side surfaces that are spaced-apart and extend substantially vertically between the lower frame segment and the upper frame segment. The system may comprise a housing having first and second support members, where the first upraised side surface of the frame is disposed adjacent to the first support member in an assembled state, and where the second upraised side surface of the frame is disposed adjacent to the second support member in an assembled state. In one embodiment, the first and second support member comprise generally I-Beam shapes.

Other systems, methods, features and advantages of the invention will be, or will become, apparent to one with skill in the art upon examination of the following figures and detailed description. It is intended that all such additional systems, methods, features and advantages be within the scope of the invention, and be encompassed by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is an exploded view depicting one example of a filter arrangement as part of a system for treating air.

FIG. 2 is a top view of the filter arrangement of FIG. 1 in an assembled state.

FIG. 3 is a side schematic view illustrating the filter arrangement of FIGS. 1-2 disposed within a housing.

FIG. 4 is a side view of a portion of an exemplary housing with the filter arrangement of FIGS. 1-3 removed for illustrative purposes, and further with a front compartment of the housing removed to depict interior features.

FIGS. 5-6 are elevated perspective views of the filter arrangement of FIGS. 1-3 before and after engagement with the housing of FIG. 4.

FIG. 7 is a side sectional view depicting an exemplary coupling of multiple layers of the filter arrangement of FIG. 1

FIG. 8 is a schematic view depicting the filter arrangement of FIG. 1 prior to engagement with a lower frame segment.

FIG. 9 is a side schematic view depicting a filter arrangement having a UV inhibitor material disposed at a first location.

FIG. 10 is a side schematic view depicting a filter arrangement having a UV inhibitor material disposed at an alternative location.

FIG. 11 is a side sectional view depicting a filter arrangement according to an alternative embodiment.

FIG. 12 is a top view of the filter arrangement of FIG. 11 in an assembled state.

FIG. 13 is a perspective view of an exemplary frame that may be used with the filter arrangement of FIGS. 11-2.

FIGS. 14-15 are top views that schematically depict the filter arrangement of FIGS. 11-13 in assembled and unassembled states, respectively, relative to support members of a housing.

FIGS. 16-17 are side sectional views of an alternative system for treating air, with a cover shown in attached and removed states, respectively.

FIG. 18 is a bottom perspective view showing an interior region of one example of a housing in accordance with FIGS. 16-17.

FIGS. 19A-19B are perspective and top views, respectively, of one embodiment of a filter arrangement having at least one alignment device.

FIGS. 20A-20D are, respectively, a bottom view of the system of FIGS. 16-17 in an assembled state, a bottom view in a disassembled state, a bottom perspective view showing exemplary protrusion of a cover and recesses of a housing, and an exemplary recess of a housing.

FIGS. 21-22 are side sectional views of an alternative system for treating air, with a cover shown in attached and removed states, respectively.

FIGS. 23A-23B are side views of a further alternative system for treating air, with a pivotable cover shown in closed and open states, respectively.

### DETAILED DESCRIPTION OF THE PREFERRED EMBODIMENTS

Referring to FIG. 1, an exemplary embodiment of a system 20 for treating air is shown and described. The system 20 may treat air by filtering, cleaning, purifying and/or other techniques, as generally explained further below.

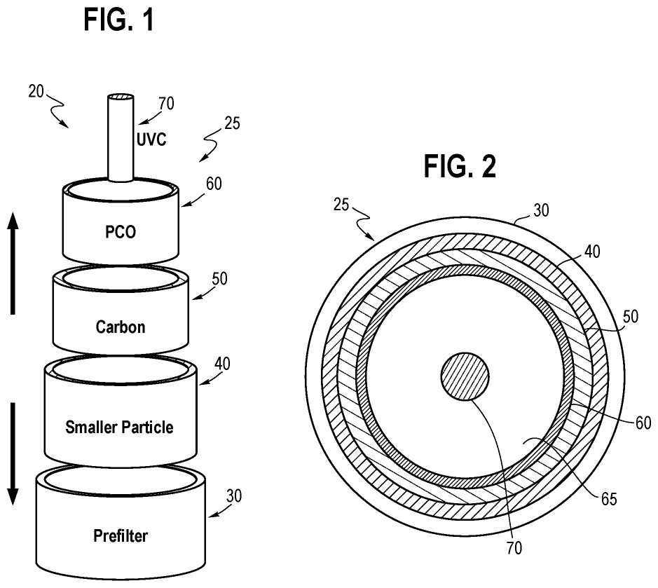

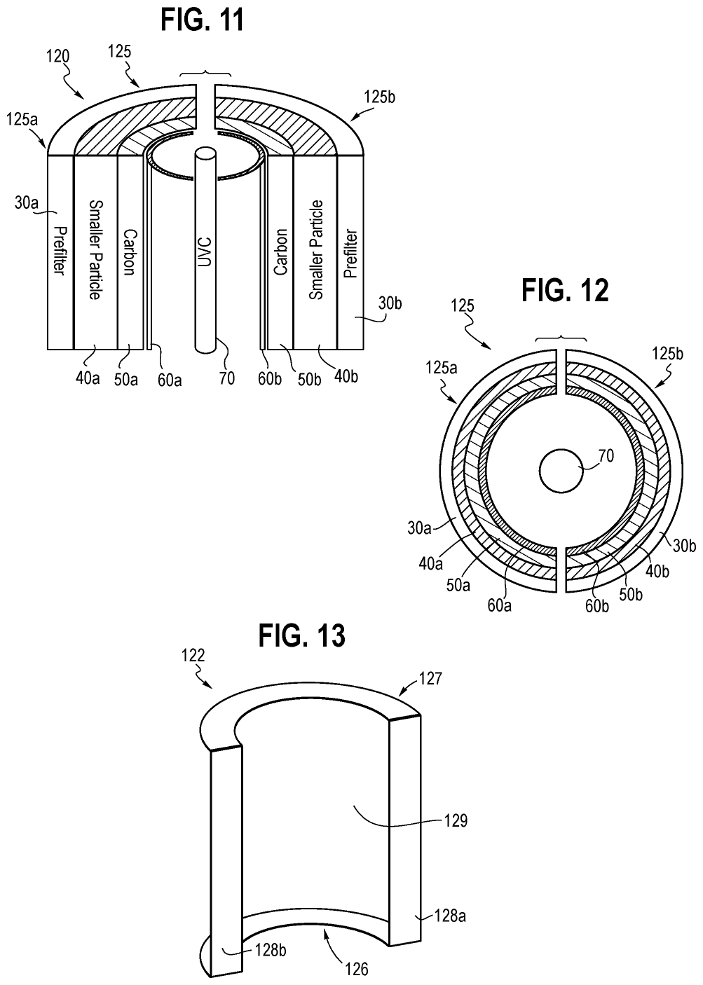

In the non-limiting embodiment depicted in FIGS. 1-2, the system 20 comprises a filter arrangement 25 that is generally cylindrical in an assembled state. In the example of FIGS. 1-2, the filter arrangement 25 comprises a fully cylindrical shape, while in the alternative embodiment of FIGS. 11-15 there is an alternative system 120 with a filter arrangement 125 having two segments 125a and 125b that collectively form a substantially cylindrical shape. It will be appreciated that, in further alternative embodiments, systems may be provided with three or more filter segments (e.g., three segments each spanning about 120 degrees around a cylindrical perimeter of the system), or systems may be provided with elliptical or oval-shaped filter assemblies, without departing from the spirit of the present embodiments.

The filter arrangement 25 comprises multiple concentric layers, where at least two of the layers comprise different materials or characteristic relative to each other. In the exemplary embodiment of FIGS. 1-2, the filter arrangement 25 comprises four concentric layers, including a pre-filter layer 30; a smaller particle filtration layer 40 (which may include a high efficiency particulate air filtration media 40 (“HEPA” layer), an ultra-low particulate air filter media (“ULPA” layer), or another media that filters smaller sized particles compared to the pre-filter layer 30); a layer comprising a carbon material 50; and a photocatalytic oxidation (or “PCO”) layer 60, which are arranged in a generally concentric manner, as shown in the exploded view of FIG. 1 and the assembled state of FIG. 2.

It will be appreciated that while four different layers 30, 40, 50 and 60 are shown, one or more of the layers may be omitted without departing from the scope of the present embodiments. For example, one of the pre-filter layer 30 or the smaller particle filtration layer 40 may be omitted (or the functions of these two layers may be combined into a single media element) without departing from the scope of the present embodiments. Alternatively, the carbon layer 50 (or another layer) may be omitted in some examples, without departing from the scope of the embodiments.

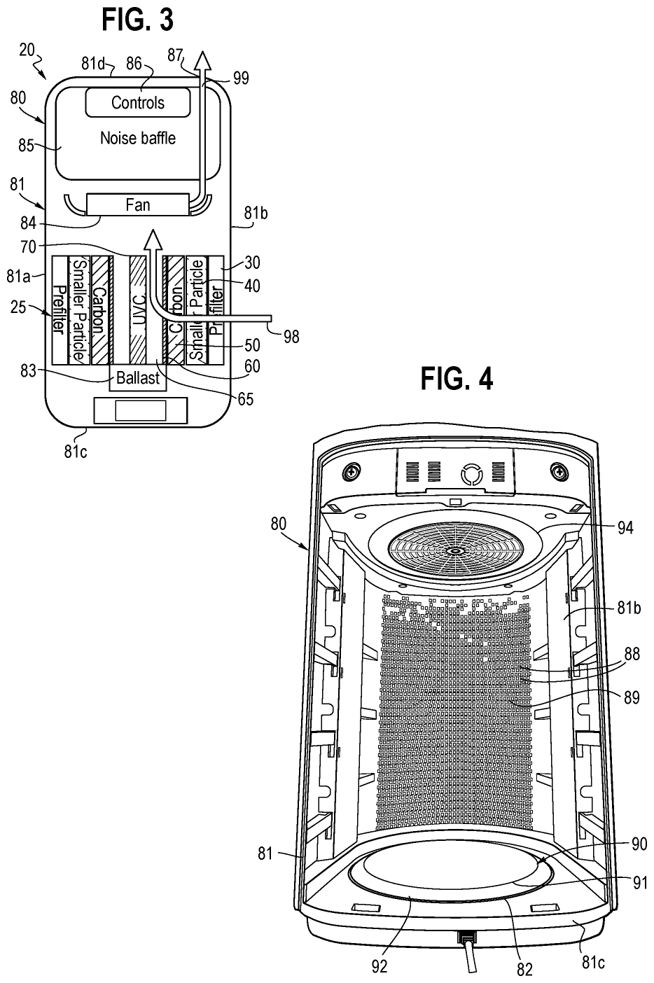

In a presently preferred embodiment, an ultraviolet light 70 (also referred to as a UV or UVC light) is disposed radially inward to the PCO layer 60, as shown in FIGS. 1-2. A flow channel 65 is provided due to an inner diameter of the PCO layer 60 being a predetermined amount larger than an outer diameter of the ultraviolet light 70, as best seen in FIGS. 2-3.

Referring to FIG. 3, the system 20 further comprises a housing 80 that is suitable for holding the filter arrangement 25 of FIGS. 1-2. In this non-limiting example, during use, air will flow in an inward direction, specifically through the pre-filter layer 30, then through the smaller particle filtration layer 40, then the carbon layer 50, and then the PCO layer 60, as indicated by the arrow 98 in FIG. 3. While only one arrow 98 is shown on the right side of FIG. 3, it will be appreciated that air can also flow in an inward direction from the left side of FIG. 3 (and optionally inward relative to the page) due to the cylindrical nature of the filter arrangement.

As shown in FIG. 3, the housing 80 comprises a main body 81 having a first side 81a, a second side 81b that generally opposes the first side 81a, a lower side 81c and an upper side 81d. A ballast 83 may be positioned near the lower side 81c to help provide stability to the housing 80 and prevent it from tipping over. The filter arrangement 25 may be disposed closer to the lower side 81c of the housing 80 compared to the upper side 81d, as depicted in FIG. 3.

One or both of the first and second sides 81a and 81b of the housing 80 may comprise a plurality of entrance apertures, such as the apertures 88 seen in FIG. 4, which allow air to enter into the housing 80. Air flows through the entrance apertures 88 in a first direction (such as primarily horizontal), as depicted by the arrow 98. Air then flows through the various layers 30, 40, 50 and 60 of the filter arrangement 25 in the direction of arrow 98, and then may flow in a more upward orientation when having entered the space 65 between the PCO layer 60 and the ultraviolet light 70, as further represented by the arrow 98 in FIG. 3.

The housing 80 may comprise a fan 84 that draws air upward from the filter arrangement 25. Air then flow in a pathway depicted by arrow 99 of FIG. 3, until exiting the housing through one or more outlet ports 87, which may be positioned in the upper side 81d of the housing as shown in FIG. 3.

While the fan 84 is depicted as being vertically above the filter arrangement 25 in FIG. 3, it will be appreciated that other placements of the fan 84 within the housing 80 may be provided without departing from the present embodiments. Further, while the one or more outlet ports 87 are depicted as being in the upper side 81d of the housing in FIG. 3, it will be appreciated that other placements of the outlet ports 87 may be provided without departing from the present embodiments, such as placements in one or both of the first and second sides 81a and 81b of the housing 80.

The system 20 optionally may comprise a noise baffle 85 disposed within the housing 80, for example, positioned partly or entirely between the fan 84 and the outlet ports 87, as depicted in FIG. 3. Further, the system 20 may comprise a control panel 86, which may be disposed on a side or upper surface of the housing 80 to be accessible to a user. The control panel 86 may comprise one or more buttons, touch screens, or other interfaces that permit a user to operate the system 20 in a desired manner, or select various settings, as will be understood by one of ordinary skill.

Advantageously, the multiple layers of the filter arrangement 25 provide an improved system for filtering, cleaning and purifying air. Each layer provides a certain function, and the orientation of the layers with respect to each other provides unique advantages, as explained further below.

The pre-filter layer 30 is configured to capture relatively large particles. In one non-limiting example, the pre-filter layer 30 may comprise a mesh or screen made of plastic, synthetic or another suitable material, which is configured to capture particles in the air having a diameter greater than about 10 microns, although it will be appreciated that other particle filtering dimensions may be selected depending on the intended usage, rating, cost, and other variables. In effect, the pre-filter layer 30 captures particles over a predetermined threshold in size so that they do not travel further downstream in the direction of the arrow 98 in FIG. 3.

The smaller particle filtration layer 40 is configured to capture relatively small particles, i.e., particles that are smaller than those intended to be captured by the pre-filter layer 30. In one non-limiting example, the smaller particle filtration layer 40 comprises a HEPA or ULPA layer that may comprise a filtration media made of plastic, fiberglass or another suitable material, which is configured to capture particles in the air having a diameter greater than about 0.3 microns, although it will be appreciated that other (and even smaller) particle filtering dimensions may be selected depending on the intended usage, rating, cost, and other variables. In effect, the smaller particle filtration layer 40 captures particles over a predetermined threshold in size, and smaller than most particles caught by the pre-filter layer 30, so that they do not travel further downstream in the direction of the arrow 98 in FIG. 3. Notably, the pre-filter layer 30 advantageously captures relatively large particles before they arrive at the smaller particle filtration layer 40 so that the smaller particle filtration layer 40 may improve its lifespan by not having to handle most relatively large particles.

The carbon layer 50 is intended to capture odors. In various examples, the carbon layer 50 may comprise an activated carbon and may include a base of paper, may be plastic or synthetic based, and may include polyester fibers impregnated with carbon or charcoal. The carbon layer 50 may also comprise pelletized carbon or charcoal. In effect, the carbon layer 50 captures odors from particles so that they do not travel further downstream in the direction of the arrow 98 in FIG. 3.

Notably, in this example, the carbon layer 50 is positioned at a location radially between the ultraviolet light 70 and the smaller particle filtration layer 40. Such arrangement has the advantage that the carbon layer 50 can protect the smaller particle filtration layer 40 from the effects of the ultraviolet light 70, thereby improving the efficacy of the smaller particle filtration layer 40 and/or improving its effective lifespan when the smaller particle filtration layer 40 is used in a system with the ultraviolet light 70. In short, the placement of the carbon layer 50 downstream from the smaller particle filtration layer 40, as opposed to upstream from the smaller particle filtration layer 40, may provide important advantages.

However, in alternative embodiments, the order of the smaller particle filtration layer 40 and the carbon layer 50 may be reversed (such that the smaller particle filtration layer is downstream relative to the carbon layer). In such embodiments, one or more optional ultraviolet light inhibiting layers or films may be positioned between the ultraviolet light 70 and the smaller particle filtration layer 40 to provide protection to the smaller particle filtration layer 40.

The PCO layer 60 is intended to neutralize pollutants, chemicals, bacteria, or viruses using a photocatalytic process. In one non-limiting example, the PCO layer 60 may include a mesh that comprises metal, plastic, or another suitable material. The mesh of the PCO layer 60 may be coated or infused with titanium dioxide, which is exposed to the ultraviolet light 70 through the space 65, as best seen in FIGS. 2-3. When exposed to the ultraviolet light 70, the material of the PCO layer 60 is energized and reacts with the passing air in a manner that neutralizes or destroys pollutants, chemicals, bacteria, or viruses. It should be appreciated that, in some embodiments, only a titanium dioxide spray can be used without a metal or plastic mesh per se.

Notably, the PCO layer 60 is positioned as the innermost layer, relative to the pre-filter layer 30, the smaller particle filtration layer 40 and the carbon layer 50, which allows the PCO layer 60 to be adjacent to the ultraviolet light 70 (without an intervening layer). Such direct exposure to the ultraviolet light 70 enables the PCO layer 60 to operate at a maximum effectiveness. In short, the placement of the PCO layer 60 adjacent to the ultraviolet light 70, as opposed to upstream from other layer 30, 40 and 50, was carefully selected to provide such advantages.

In sum, each of the layers 30, 40, 50 and 60 of the filter arrangement 25 provides unique functions and advantages, and the sequential concentric placement of each layer relative to one another was provided for maximum effectiveness of the overall system 20.

It will be appreciated that the filter arrangement 25 could have additional filter layers without departing from the present embodiments. However, if such additional layers are used, consideration should be made to maintain the relative placements of the previously described layers 30, 40, 50 and 60 relative to each other, and relative to the ultraviolet light 70, to maintain most or all of the advantages described above.

The filter arrangement 25 may be provided to a user such that the layers 30, 40, 50 and 60 are assembled or secured together, i.e., not intended to be separated, such that the filter arrangement 25 is removed all as one unit. In this embodiment, when it is time to replace the parts, all of the layers of the filter arrangement 25 may be discarded at once, and a new filter arrangement 25 comprising all four layers may be installed. Alternatively, it will be appreciated that one or more of the layers 30, 40, 50 and 60 could be separate from the others, and assembled together by a user to form the filter arrangement 25 into the shape shown in FIGS. 2-3, in which case the various filter layers 30, 40, 50 and 60 could be removed and replaced one at a time. With regard to PCO layer 60 in particular, PCO does not have to be replaced like conventional filter media, and therefore it may be beneficial to provide the PCO layer 60 as a separate layer that can be installed in the orientation of FIGS. 2-3, though not affixed permanently to the other layers 30, 40 and 50.

Further, the ultraviolet light 70 may be releasably secured to the housing 80 near a lower or upper end region of the ultraviolet light 70, so long as the generally cylindrical layers 30, 40, 50 and 60 are capable of being installed in a manner that circumferentially surround the ultraviolet light 70, and allow for subsequent removal from their positions surrounding the ultraviolet light 70. For example, the bottom region of the ultraviolet light 70 may be releasably secured adjacent to the ballast 83, or the top region of the ultraviolet light 70 may be releasably secured adjacent to the fan 84 or an upper sealing ring 94.

Referring now to FIGS. 4-6, the system 20 further comprises an engagement mechanism 90 designed to secure the filter arrangement 25 relative to the housing 80, particularly when the filter arrangement 25 is in an operative state. In the embodiment depicted, the engagement mechanism 90 comprises a spring-loaded base 91, which in this example comprises a generally circular shape, as shown in FIG. 4 (with the filter arrangement 25 removed for illustrative purposes). The spring-loaded base 91 comprises an outer perimeter 92 that is housed within a recess 82 formed near the lower side 81c of the housing 80, as shown in FIG. 4. One or more compression springs (not shown in FIG. 4) may be disposed beneath the spring-loaded base 91 in order to bias the spring-loaded base 91 in an upward direction.

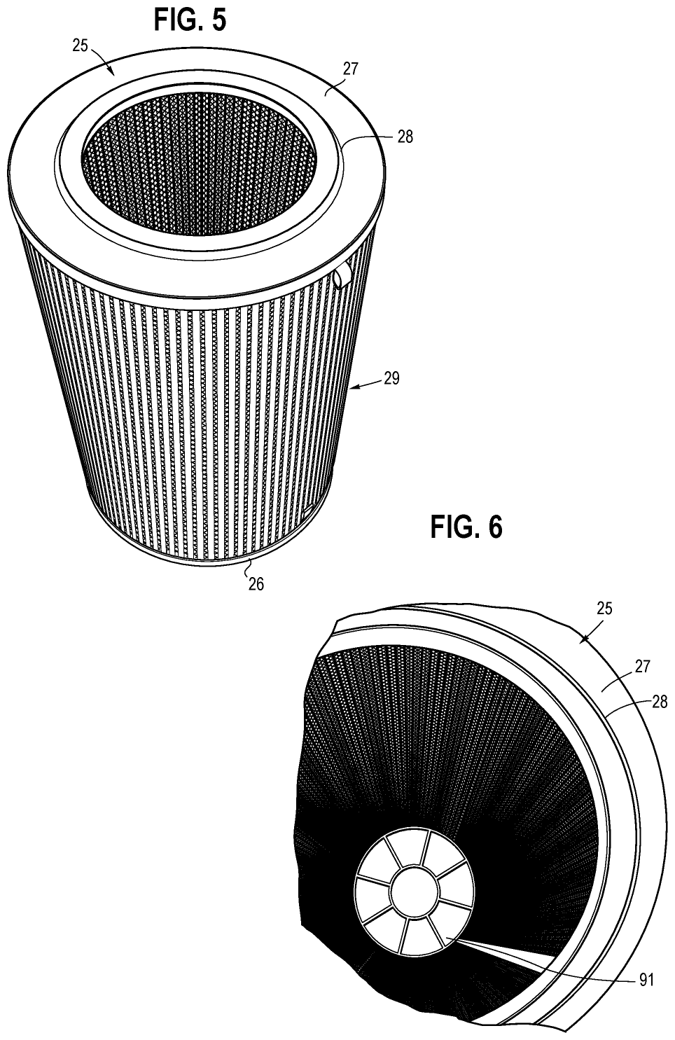

As shown in FIG. 5, the filter arrangement 25 may comprise a lower frame segment 26 and an upper frame segment 27. In this example, the lower and upper frame segments 26 and 27 each comprise generally circular shapes that approximate a collective shape formed by the adjacent layers 30, 40, 50 and 60 of the filter arrangement 25. The lower frame segment 26 may be secured to lower regions of one or more of the layers 30, 40, 50 and 60, for example, using an adhesive, glue, mechanical engagement or other means. Similarly, the upper frame segment 27 may be secured to upper regions of one or more of the layers 30, 40, 50 and 60, for example, using an adhesive, glue, mechanical engagement or other means. In this manner, the layers 30, 40, 50 and 60 are secured at their lower and upper regions relative to the lower and upper frame segments 26 and 27. However, as shown in FIG. 5, a central region 29 of the filter arrangement 25 lacks coverage by the lower and upper frame segments 26 and 27, which enables air intake through the central region 29 in the direction of the arrow 98 of FIG. 2. It is noted that at least a portion of the central region 29 of the filter arrangement 25 will be disposed adjacent to the entrance apertures 88 of the housing 80, when in the assembled state of FIG. 6.

In order to secure the filter arrangement 25 relative to the housing 80, a user positions the filter arrangement 25 of FIG. 5 into a central open space 89 of the housing 80 of FIG. 4, until the lower frame segment 26 of the frame arrangement 25 at least partly overlaps with the spring-loaded base 91. The user then applies a downward force upon the filter arrangement 25 to overcome the spring resistance, and urge a temporary downward movement of the spring-loaded base 91. At this time, the remainder of the filter arrangement 25 can be positioned within the open space 89 of the housing 80, such that the upper frame segment 27 overlaps with a sealing ring 94 positioned at an upper region of the housing 80, as seen in FIG. 4. When the user lessens or removes the downward force upon the filter arrangement 25, the spring-loaded base 91 will bias the filter arrangement 25 upward, such that the upper frame segment 27 frictionally engages the sealing ring 94. In one non-limiting example, the upper frame segment 27 may comprise an upraised ring 28, depicted in FIG. 5, which nests within a flexible or elastomeric material of the sealing ring 94 due to the upward bias provide by the spring-loaded base 91, thereby ensuring a solid seal. At this time, the entrance apertures 88 of the housing 80 are aligned with the central region 29 of the filter arrangement 25, such that air may flow through the filter arrangement 25 via the arrow 98 of FIG. 3. When it becomes desirable to remove the filter arrangement 25 from the housing 80, e.g., to change the filter media, then the user provides a downward force upon the filter arrangement 25 to depress the spring-loaded base 91 and permit withdrawal.

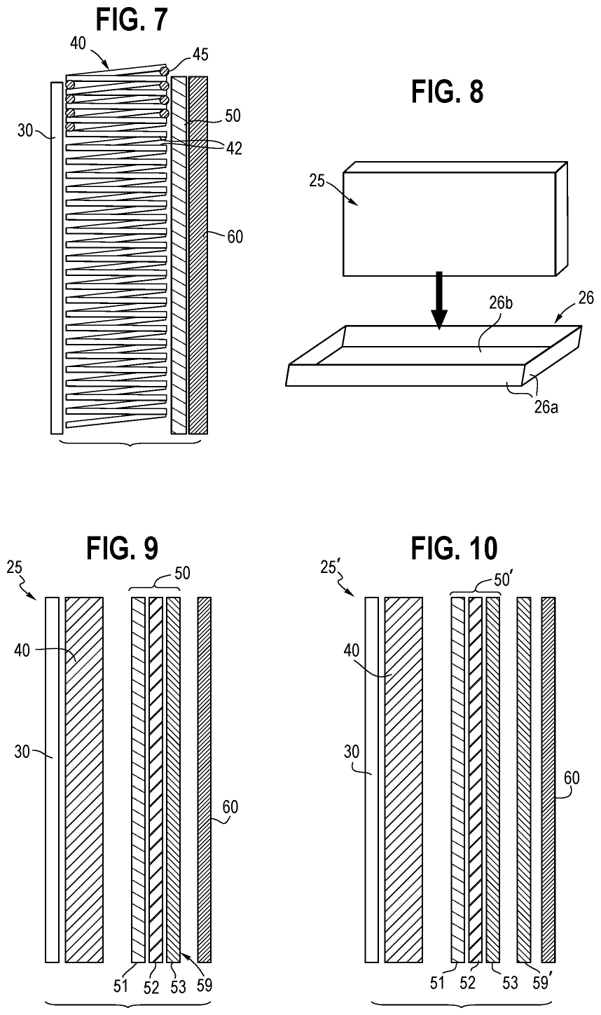

Referring to FIG. 7, in one example, an adhesive 45 may be used to facilitate securement of one or more of the layers 30, 40, 50 or 60 relative to each other. In this example, the smaller particle filtration layer 40 is selectively adhered to each of the pre-filter layer 30 and carbon layer 50 at pleats 42 of the smaller particle filtration layer 40, as shown in FIG. 7. Such adhesive placement can maintain a desired spacing of pleats 42 of the smaller particle filtration layer 40, as depicted in FIG. 7.

Referring to FIG. 8, the four filter layers 30, 40, 50 and 60 are schematically shown as a single filter arrangement 25, which during manufacture is being secured relative to the lower frame segment 26 of FIG. 5. In one embodiment, the lower frame segment 26 may comprise a plurality of upraised side surfaces 26a, with a valley 26b formed in a space between the upraised side surfaces 26b, as shown in FIG. 8. An adhesive may be disposed in the valley 26b, such that placement of the filter arrangement 25 into the valley 26b secures the lower end of the filter arrangement 25 relative to the lower frame segment 26. At this time, the lower outer perimeter of the filter arrangement 25 may frictionally abut an inner region of the upraised side surfaces 26a, with the adhesive facilitating a secure connection at these locations. As will be appreciated, the filter arrangement 25 may be secured relative to the upper frame segment 27 in a generally identical manner.

Referring to FIGS. 9-10, the filter arrangement 25 is shown as having an optional UV inhibitor material 59. In one example, the UV inhibitor material 59 may comprise an additive, such as to a plastic makeup, that reduces the impact of UV light deteriorating the quality of the plastics. In the embodiment of FIG. 9, the UV inhibitor material 59 can bond with a portion of the carbon layer 50. In this example, the carbon layer 50 comprises polyethylene terephthalate (PET) segments 51 and 53, with activated carbon 52 disposed therebetween. The layers 51, 52 and 53 may be thermally bonded to hold the activated carbon 52 in place. In this example, the UV inhibitor material 59 bonds with the PET segment 53 closer to the PCO layer 60, as depicted in FIG. 9. In the embodiment of FIG. 10, an alternative filter arrangement 25′ comprises a stand-alone UV inhibitor material 59′ disposed between the carbon layer 50 and the PCO layer 60, which can be beneficial in instances where it is difficult to secure the UV inhibitor material 59 directly to the carbon layer 50. As noted above, such arrangement of a UV inhibitor 59 or 59′ at the carbon layer 50, or slightly downstream from the carbon layer 50, has the advantage that the carbon layer 50 protects the smaller particle filtration layer 40 from the effects of the ultraviolet light 70, thereby improving the efficacy of the smaller particle filtration layer 40 and/or improving its effective lifespan when the smaller particle filtration layer 40 is used in a system with the ultraviolet light 70. As will be appreciated, while one example of a carbon layer 50 has been depicted having PET segments 51 and 53 on each side of activated carbon 52, the carbon layer 50 may also comprise honeycomb shapes with mesh on each side to hold carbon pellets, or may comprise bonded carbon, and the like.

Referring now to FIGS. 11-15, an alternative system 120 is shown with a filter arrangement 125 having two segments 125a and 125b that collectively form a substantially cylindrical shape.

In many respects, the alternative system 120 is similar to the system 20 explained above, with the main exception that the fully cylindrical layers forming the filter arrangement 25 are replaced with a filter arrangement 125 comprising two segments 125a and 125b in this alternative embodiment. Thus, the discussion of the components of the system 20 of FIGS. 1-10 above generally applies to the system 120 in FIGS. 11-15, with like reference numerals from FIGS. 1-10 corresponding to like parts in FIGS. 11-15, with a few main exceptions for FIGS. 11-15 noted below.

In FIGS. 11-12, each of the filter arrangement segments 125a and 125b comprises generally opposing “C” or “Clam” shapes, which may span about 180 degrees or slightly less, e.g., between about 150 and about 179 degrees. Each of the segments 125a and 125b may comprise an identical construction, with each segment 125a and 125b comprising the four layers identified above disposed adjacent to each other and spanning slightly less than 180 degrees along each side of its respective segment. Specifically, the first segment 125a comprises a pre-filter layer 30a, a smaller particle filtration layer 40a, a carbon layer 50a and a PCO layer 60a, while the second segment 125b comprises a pre-filter layer 30b, a smaller particle filtration layer 40b, a carbon layer 50b and a PCO layer 60b, as depicted in FIGS. 11-12. An ultraviolet light 70 is disposed internal to the PCO layers 60a and 60b of the first and second segments 125a and 125b, as depicted in FIGS. 11-12. It is noted that, in FIGS. 11-12, the four layers are shown outside of a filter frame for illustrative purposes.

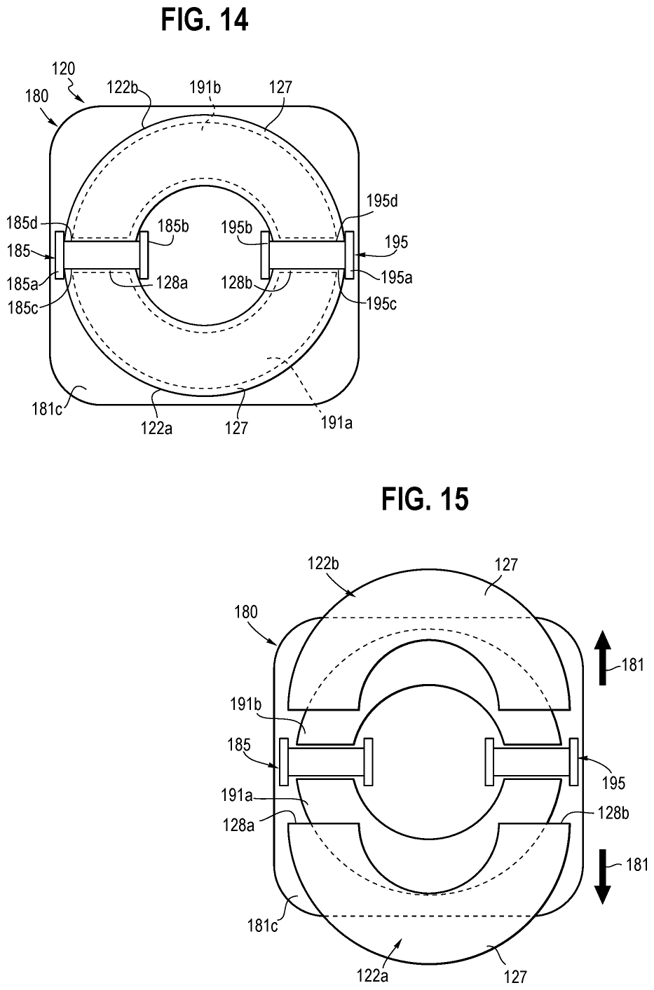

Referring to FIG. 13, in one embodiment, each of the segments 125a and 125b of the filter arrangement 125 may be secured within a frame 122 that comprises a lower frame segment 126, an upper frame segment 127, and upraised side surfaces 128a and 128b that are disposed slightly less than 180 degrees apart. Each of the upraised side surfaces 128a and 128b extends substantially vertically between the lower frame segment 126 and the upper frame segment 127. The lower frame segment 126 and the upper frame segment 127 each comprise a generally C or clam shape, as shown in FIG. 13, with an open central region 129 extending therebetween. During use, the filter segment 125a is secured within a first frame 122a (shown in FIG. 14) such that lower regions of the layers 30a, 40a, 50a and 60a are disposed adjacent to the lower frame segment 126, such that upper regions of the layers 30a, 40a, 50a and 60a are disposed adjacent to the upper frame segment 127, and such that circumferentially-spaced end regions of the layers 30a, 40a, 50a and 60a are disposed adjacent to the upraised side surfaces 128a and 128b, optionally with adhesives holding the layers relative to one or more of the surfaces of the frame 122. As will be appreciated, the layers 30b, 40b, 50b and 60b of the other filter segment 125b are secured within a second frame 122b, shown in FIG. 14, in a similar manner.

Referring to FIGS. 14-15, top views schematically depict the filter arrangement 125 of FIGS. 11-13 in assembled and unassembled states, respectively, relative to a housing 180. The housing 180 is generally similar to the housing 80 of FIGS. 3-6, with main exceptions noted below. In the example of FIGS. 14-15, the housing 180 comprises two support members 185 and 195, which may be disposed about 180 degrees apart with respect to one another. The support members 185 and 195 each comprise lower surfaces that are affixed to a lower side 181c of the housing 180, and which extend upwardly therefrom, such that the support members 185 and 195 are primarily vertically oriented.

As shown in FIGS. 14-15, in one non-limiting embodiment, the support member 185 comprises a generally “I-Beam” shape having an outer region 185a and an inner region 185b that are generally parallel to one another, with central regions 185c and 185d extending laterally therebetween. Similarly, the support member 195 comprises a generally “I-Beam” shape having an outer region 195a and an inner region 195b that are generally parallel to one another, with central regions 195c and 195d extending laterally therebetween

In the assembled state of FIG. 14, the upraised side surface 128a of the first frame 122a is disposed adjacent to the central region 185c of the support member 185, while the opposing upraised side surface 128b of the first frame 122a is disposed adjacent to the central region 195c of the support member 195. Similarly, the upraised side surface 128b of the second frame 122b is disposed adjacent to the central region 185d of the support member 185, while the opposing upraised side surface 128a of the second frame 122b is disposed adjacent to the central region 195d of the support member 195, as depicted in FIG. 14.

In order to hold the filter frames 122a and 122b in their assembled states relative to the housing 180, two separate spring-loaded bases 191a and 191b are provided. The spring-loaded bases 191a and 191b may be similar to the spring-loaded base 91 of FIG. 4, with the exception that they span about 180 degrees, or slightly less, around a perimeter of the housing 180. Notably, the overall surface area of the spring-loaded bases 191a and 191b may closely match the surface area of the lower frame segments 126 of the first and second frames 122a and 122b. In this embodiment, the first frame 122a is pressed downward relative to the spring-loaded base 191a to facilitate securement of the first frame 122a relative to the housing 180, while the second frame 122b is pressed downward relative to the spring-loaded base 191b to facilitate securement of the second frame 122b relative to the housing 180, in a manner similar to the method described in FIGS. 4-6 above. Optionally, the upper frame segment 127 of the first and second frames 122a and 122b may comprise upraised rings, similar to ring 28 of FIG. 5, to engage a sealing surface (similar to ring 94) positioned near the upper surface of the housing, as generally explained with respect to FIGS. 4-6 above. As will be appreciated, other sealing rings or surfaces may be provided, for example, at the central regions 185c, 185d, 195c and 195d of the support members 185 and 195, or on the upraised side surfaces 128a and 128b of the frames 122a and 122b, or other regions where a sealing function may be beneficial.

In order to achieve the disassembled state of FIG. 15, a user presses downward upon the filter frames 122a and 122b to overcome the force provided by the spring-loaded bases 191a and 191b, respectively. The user then moves the opposing filter frames 122a and 122b away from the support members 185 and 195, as generally indicated by the arrows 181 in FIG. 15.

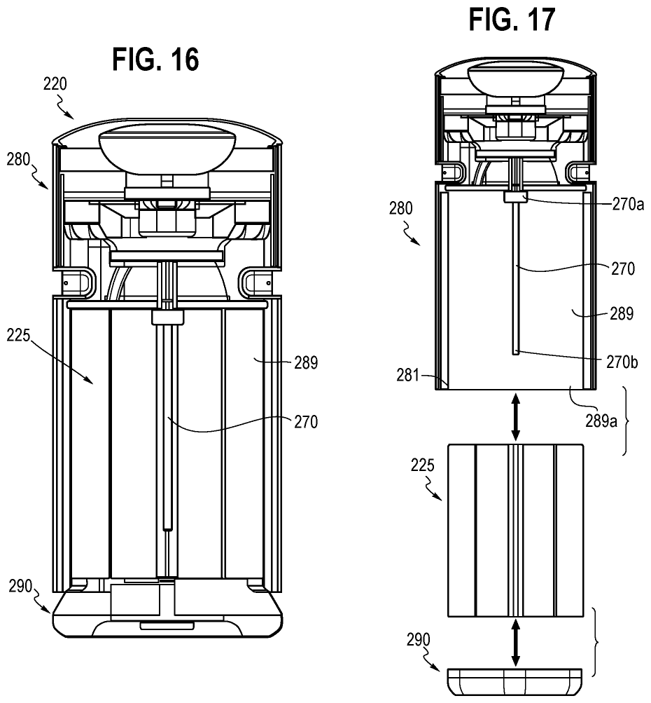

Referring now to FIGS. 16-23B, alternative embodiments are shown in which a cover of the housing is removable, or pivotable from a closed state to an open state, in order to facilitate removal of the filter arrangement from the housing.

In the example of FIGS. 16-20, a system 220 for treating air is shown and described, which is similar to the system 20 of FIGS. 1-10 in many respects, for example, since the system 220 comprises a filter arrangement 225 that has a fully cylindrical shape in an assembled state like the filter arrangement 25 of the system 20. The filter arrangement 225 also comprises multiple concentric layers, including by way of example and without limitation, at least multiple layers chosen among the pre-filter layer 30, the smaller particle filtration layer 40, the layer comprising a carbon material 50, and the photocatalytic oxidation (or “PCO”) layer 60, which are explained in detail in FIGS. 1-2 above (although not labeled in FIGS. 16-23B for simplicity). These layers may be provided in the embodiments of FIGS. 16-23B in the same upstream to downstream order explained above, or in alternative orders, or select layers may be omitted and/or additional layers may be added in the embodiments of FIGS. 16-23B.

The system 220 of FIGS. 16-20 comprises a housing 280 that is configured to receive the filter arrangement 225, as shown in FIGS. 16-17 and FIGS. 20A-20D. The housing 280 may be similar to the housing 80 of FIGS. 3-4, with notable exceptions for the housing 280 explained below.

In the embodiment of FIGS. 16-20, the system 220 further comprises a cover 290, which in this example is positioned at the base of the system, i.e., closer to the ground during operation. However, in alternative embodiments, it will be appreciated that the cover 290 may be positioned near a top region of the system 220, or on a side surface, without departing from the present embodiments.

As depicted in FIGS. 16-17 and FIGS. 20A-20D, and explained further below, the filter arrangement 225 may be removably positioned within an open space 289 of the housing 280. The open space 289 has a receiving region 289a, as depicted in FIG. 17, such that the filter arrangement 225 can be inserted and removed from the open space 289 via the receiving region 289a.

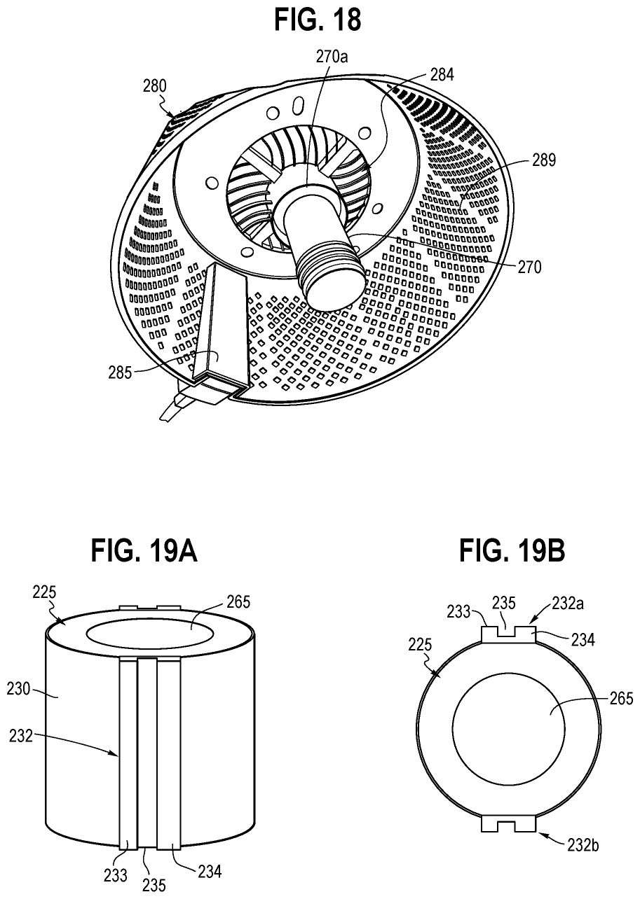

In the embodiment of FIGS. 16-18, an ultraviolet light 270 (which may be similar or identical to the ultraviolet light 70 described above) may be affixed to the housing 280 at a first end 270a and extends to a second end 270b that is free from direct attachment to the housing 280. FIG. 18 depicts one example of a coupling of the first end 270a of the ultraviolet light 270 to the housing 280 at a location adjacent to a fan 284 of the housing 280.

As discussed in FIG. 2 above, a flow channel 65 is provided within the filter arrangement 25 due to an inner diameter of the PCO layer 60 being a predetermined amount larger than an outer diameter of the ultraviolet light 70. A similar flow channel 265 is referenced in FIGS. 19A-19B. Therefore, in the embodiment of FIGS. 16-20, the filter arrangement 225 can be inserted into the receiving region 289a of the housing 280 such that the flow channel 265 of the filter arrangement 225 co-axially passes around the ultraviolet light 270 in an insertion direction from the second end 270b towards the first end 270a, until the filter arrangement 225 is disposed substantially or entirely within the open space 289 of the housing 280.

Referring to FIGS. 19A-19B, in one embodiment, the filter arrangement 225 may comprise at least one alignment device 232, which may facilitate placement of the filter arrangement 225 into the open space 289 of the housing 280, particularly in a manner that reduces or avoids inadvertent contact and damage to the ultraviolet light 270 during insertion and removal of the filter arrangement 225. In one non-limiting example, the at least one alignment device 232 comprises first and second alignment devices 232a and 232b, which are positioned at locations that are spaced-apart about 180 degrees from one another around a perimeter of the filter arrangement 225, as depicted in FIG. 19B. However, it will be appreciated that greater or fewer alignment devices may be provided, and their spacing around the filter arrangement may be varied to encompass other locations.

In this example of FIGS. 19A-19B, the first and second alignment devices 232a and 232b each comprise axially extending rails 233 and 234, with a recessed track 235 positioned therebetween. The first and second alignment devices 232a and 232b may be secured to an exterior surface of the outermost layer 230 of the filter arrangement 225, which may be a pre-filter layer 230 similar to the layer 30 described above. The recessed track 235 is adapted to receive a complementary protrusion extending radially inward from an interior surface of the housing 280. In one example, the complementary protrusion is an inwardly-extending portion 285 of the housing 280 as depicted in FIG. 18, within which electrical components or the like may be carried (or this space behind the inwardly-extending portion 285 may be hollow or solid). In this example, the inwardly-extending portion 285 extends most of the axial length of the open space 289 of the housing 280, and would be axially co-extensive with a majority or all of the recessed track 235 of the filter arrangement 225. However, it will be appreciated that the inwardly-extending portion 285 may extend less than the entire vertical length of the open space 289 and still be effective to guide the filter arrangement 225 during its placement within the housing 280.

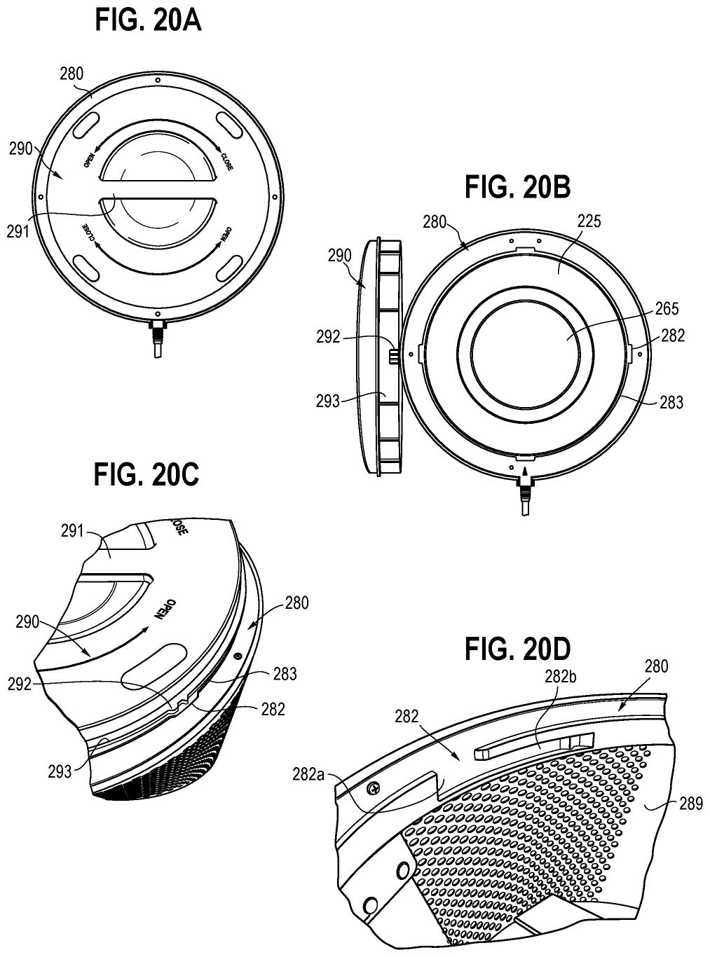

Referring to FIGS. 20A-20D, further details of one embodiment of the cover 290 of FIGS. 16-17, and its interaction with the housing 280, are explained in greater detail. It should be noted that FIGS. 20A-20D depict bottom views (or perspective views from a bottom region towards a top region) for illustrative purposes, as contrasted with prior views that showed the system upright. In the embodiment of FIGS. 20A-20D, the cover 290 may comprise a user-actuated handle 291 that allows the cover 290 to be removably detached from engagement with the housing 280 via a threaded engagement near an engagement region 281 of the housing. By way of example and without limitation, the threaded engagement may encompass at least one protrusion 292 on an exterior facing region 293 of the cover 290, which can selectively engage a recess 282 disposed on an interior facing region 283 of the housing 280, as depicted in FIGS. 20B-20D.

As best seen in FIGS. 20B-20C, the at least one protrusion 292 of the cover 290 may be in the form of a circle, ellipse, square or another suitable shape, which may extend a short distance radially away from a remainder of the cover 290. The recess 282 of the housing 280 may comprise an entrance region 282a and an elongated segment 282b, as shown in FIG. 20D. Each of the entrance region 282a and the elongated segment 282b may comprise a channel width that is slightly larger than an exterior width of the at least one protrusion 292.

In use, in order to move the cover 290 from the assembled state of FIG. 20A to the disassembled state of FIG. 20B, a user rotates the cover 290, e.g., via the handle 291. During rotation, the protrusion 292 moves from the elongated segment 282b of the recess 282 towards the entrance region 282a. Once the protrusion 292 is aligned with the entrance region 282a, the user can pull the cover 290 away from the housing 280 to achieve the disassembled state. It will be appreciate that in order to secure the cover 290 to the housing 280, a reverse sequence of steps may be applied.

In FIGS. 20A-20D, it will be appreciated that multiple pairs of protrusions 292 and recesses 282 may be disposed around the perimeter of the system 220, e.g., two to six spaced-apart recesses 282 may be provided in the housing 280 and configured to receive a complementary two to six protrusions on the cover 290. Additionally, it will be appreciated that in lieu of the protrusions 292 and recesses 282 depicted, the cover 290 may comprise external helical threading around its perimeter that is adapted to removably engage internal threading disposed around a perimeter of the housing 280 near the securement region 281 of the housing.

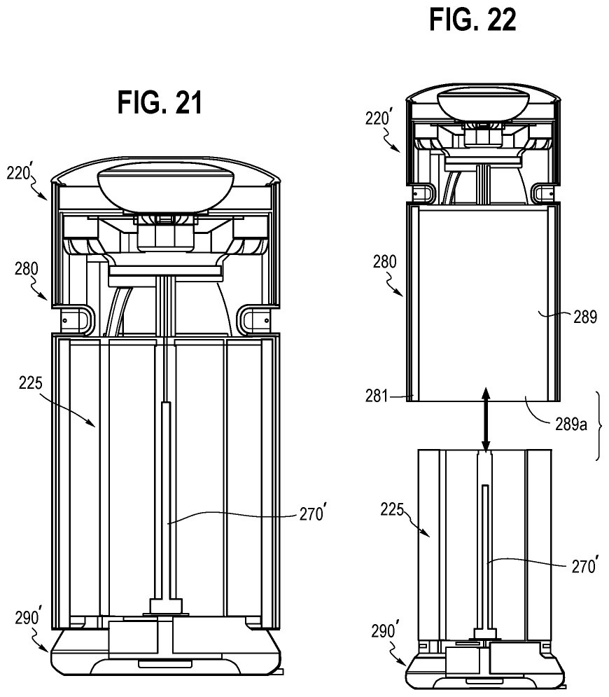

Referring now to FIGS. 21-22, an alternative system 220′ for treating air is similar to the system 220 of FIGS. 16-20, with the main exception that the filter arrangement 225 and an ultraviolet light 270′ are configured to be secured to an alternative cover 290′. The filter arrangement 225 and the ultraviolet light 270′ may be secured to the cover 290′ by a permanent or temporary mechanism, including a mechanical coupling, frictional engagement, threaded engagement, adhesives and the like. In some examples, the user may detach the cover 290′ from the housing 280 in the manner described in FIGS. 20A-20D; however, unlike the embodiment of FIGS. 20A-20D in which only the cover 290 disengages from the housing, in this example of FIGS. 21-22 the cover 290′ disengages together with the filter arrangement 225 and the ultraviolet light 270′ secured to the cover 290′. In the embodiment of FIGS. 21-22, after the user has removed the cover 290′, filter arrangement 225 and ultraviolet light 270′ together, then the filter arrangement 225 and/or the ultraviolet light 270′ may be detached from the cover 290′ for exchanging with newer components, as needed. Once the filter arrangement 225 and/or the ultraviolet light 270′ are re-attached to the cover 290′, the collective group may be re-inserted into the housing 280.

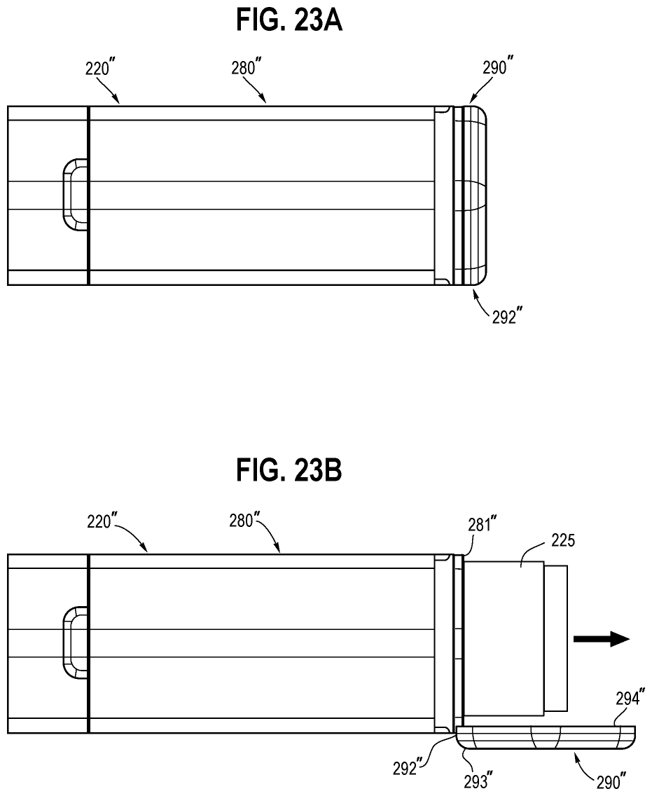

Referring now to FIGS. 23A-23B, an alternative system 220″ for treating air is similar to the system 220 of FIGS. 16-20, with the main exception that an alternative cover 290″ is pivotably attached to a housing 280″ instead of being fully removable. In FIGS. 23A-23B, a hinge 292″ may be used to secure a first region 293″ of the cover 290″ to the housing 280″. A second region 294″ of the cover 290″, which may be at a location substantially opposing the first region 293″, is configured to selectively couple to a securement region 281″ of the housing 280″. The selective coupling may be achieved using a frictional engagement between the second region 294″ and an interior region of the housing 280″, or magnetic attachments disposed on each of the second region 294″ and the securement region 281″, or using mechanical securement devices. As shown in FIG. 23B, when the cover is pivoted to the open state, which may be about 90 degrees or more relative to the closed state, then the filter arrangement 225 may be axially removed from the housing 280″.

It will be appreciated that while FIGS. 16-23B show a removable or pivotable cover being used in conjunction with a filter arrangement that is fully cylindrical, the removable or pivotable cover may alternatively be used in conjunction with the filter arrangement 125 of FIGS. 11-15 having two segments 125a and 125b that collectively form a substantially cylindrical shape, or with systems having three or more filter segments (e.g., three segments each spanning about 120 degrees around a cylindrical perimeter of the system) that form cylindrical, elliptical or oval-shaped filter assemblies, without departing from the spirit of the present embodiments.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. A system for treatment of air, the system comprising:
a pre-filter layer;
a smaller particle filtration layer;
a carbon layer; and
a photocatalytic layer,
wherein, among the four layers, the pre-filter layer is the furthest upstream in a direction of air flow, and the photocatalytic layer is the furthest downstream in a direction of air flow.

2. The system of claim 1, wherein the pre-filter layer is upstream in a direction of air flow relative to the smaller particle filtration layer, wherein the smaller particle filtration layer is upstream in a direction of air flow relative to the carbon layer, and wherein the carbon layer is upstream in a direction of air flow relative to the photocatalytic layer.

3. The system of claim 1, wherein the smaller particle filtration layer comprises one of a high efficiency particulate air (“HEPA”) filtration media, or an ultra-low particulate air (“ULPA”) filter media.

4. The system of claim 1, further comprising an ultraviolet light, wherein the ultraviolet light is disposed downstream from the photocatalytic layer in a direction of air flow.

5. The system of claim 1, where a filter arrangement is provided in which each of the pre-filter layer, the smaller particle filtration layer, the carbon layer, and the photocatalytic layer comprise a continuous cylindrical layer.

6. The system of claim 5, wherein the filter arrangement is secured to a frame having a lower frame segment and an upper frame segment, with an open central region disposed between the lower and upper frame segments.

7. The system of claim 6, further comprising a housing having a spring-loaded base, wherein the lower frame segment of the frame is configured to be biased upward by the spring-loaded base in an assembled state.

8. The system of claim 1, where a filter arrangement is provided having first and second segments, wherein:
the first segment comprises generally clam-shaped portions of each of the pre-filter layer, the smaller particle filtration layer, the carbon layer, and the photocatalytic layer; and
the second segment comprises generally clam-shaped portions of each of the pre-filter layer, the smaller particle filtration layer, the carbon layer, and the photocatalytic layer,
wherein, during use, the first and second segments are positioned adjacent to one another to form a substantially cylindrical shape.

9. The system of claim 8, wherein the first segment of the filter arrangement is secured to a frame having a lower frame segment spanning less than 180 degrees, an upper frame segment spanning less than 180 degrees, and first and second upraised side surfaces that are spaced-apart and extend substantially vertically between the lower frame segment and the upper frame segment.

10. The system of claim 9, wherein an adhesive is disposed on the lower frame segment to secure the first segment of the filter arrangement relative to the lower frame segment during use.

11. The system of claim 9, further comprising a housing having first and second support members, wherein the first upraised side surface of the frame is disposed adjacent to the first support member in an assembled state, and wherein the second upraised side surface of the frame is disposed adjacent to the second support member in an assembled state.

12. The system of claim 11, where the first and second support members comprise generally I-Beam shapes.

13. A system for treatment of air, the system comprising:
a photocatalytic layer; and
an ultraviolet light;
wherein the ultraviolet light is disposed downstream from the photocatalytic layer in a direction of air flow, and
wherein air flow is routed through the photocatalytic layer and then exposed to the ultraviolet light.

14. The system of claim 13, wherein the photocatalytic layer comprises a generally cylindrical shape comprising a continuous cylindrical layer or two clam-shaped layers disposed adjacent to one another, wherein the ultraviolet light is disposed radially inward relative to the continuous cylindrical layer or the two clam-shaped layers.

15. The system of claim 13, further comprising:
a pre-filter layer;
a smaller particle filtration layer; and
a carbon layer,
wherein the pre-filter layer is upstream in a direction of air flow relative to the smaller particle filtration layer, wherein the smaller particle filtration layer is upstream in a direction of air flow relative to the carbon layer, and wherein the carbon layer is upstream in a direction of air flow relative to the photocatalytic layer.

16. The system of claim 15, where a filter arrangement is provided in which each of the pre-filter layer, the smaller particle filtration layer, the carbon layer, and the photocatalytic layer comprise a continuous cylindrical layer.

17. The system of claim 15, where a filter arrangement is provided having first and second segments, wherein:
the first segment comprises generally clam-shaped portions of each of the pre-filter layer, the smaller particle filtration layer, the carbon layer, and the photocatalytic layer; and
the second segment comprises generally clam-shaped portions of each of the pre-filter layer, the smaller particle filtration layer, the carbon layer, and the photocatalytic layer,
wherein, during use, the first and second segments are positioned adjacent to one another to form a substantially cylindrical shape.

18. A system for treatment of air, the system comprising:
a smaller particle filtration layer;
a carbon layer; and
an ultraviolet light,
wherein the ultraviolet light is disposed downstream from the carbon layer in a direction of air flow, and wherein the smaller particle filtration layer is disposed upstream from the carbon layer in a direction of air flow.

19. The system of claim 18, further comprising a photocatalytic layer, wherein the photocatalytic layer is disposed between the carbon layer and the ultraviolet light.

20. The system of claim 19, further comprising a pre-filter layer, wherein the pre-filter layer is disposed upstream from the smaller particle filtration layer in a direction of air flow.
